(19) United States
(12) Patent Application Publication
(10) Pub. No.: US 2002/0011367 A1
(43) Pub. Date: Jan. 31, 2002

(54) Autonomously navigating robot system

(76) Inventor: Marina Kolesnik, Koenigswinter (DE)

Correspondence Address: BIRCH STEWART KOLASCH & BIRCH, PO BOX 747, FALLS CHURCH, VA, 22040-0747, US

(21) Appl. No.: 09/915,350

(22) Filed: Jul. 27, 2001

(30) Foreign Application Priority Data
Jul. 27, 2000 (EP) 00 116 088.6

(51) Int. Cl. B62D 1/24

(52) U.S. Cl. 180/168; 180/167

(57) ABSTRACT

In an autonomously navigating robot system orientation is effected on the basis of a current laser projected line pattern (44,48) taken by a camera (20) and on the basis of previous examinations of the course and arrangement of reflected line patterns (44,48) obtained during projection of said line patterns by means of a laser projector (18) in different known directions in the surrounding.

### BACKGROUND OF THE INVENTION

The present invention relates to an autonomously navigating robot system, and in particular to a robot system allowing efficient relative orientation of the robot in its surroundings.

In a surrounding with geometrically classified objects autonomously navigating robot systems require an orientation aid which helps them to move in these surroundings. Said orientation aids may e.g. be landmarks, i.e. natural or artificial points of orientation which the robot system recognizes with the help of a suitable detection device. The previously known detection devices need to be calibrated and in most cases require measurement of the distance between the robot and the landmark. Alternative robot systems make use of the pattern recognition (of the landmarks) in pictures taken by a camera for the purpose of orientation in their surrounding, or they orientate themselves on the basis of a three-dimensional reconstruction of the surrounding. All these procedures are rather complicated with regard to both the required hardware and the software.

### SUMMARY OF THE INVENTION

It is an object of the present invention to provide an autonomously navigating robot system which orientates itself in its surrounding in a simplified manner.

According to the invention an autonomously navigating robot system is suggested which is provided with:

a chassis comprising a driving device for maneuvring the chassis in a surrounding,

a device arranged on the chassis for generating electromagnetic radiation and directed emission of said radiation into the surrounding,

wherein the electromagnetic radiation is emitted in the form of at least two bars extending at an angle of non-zero relative to each other,

a device arranged on the chassis for detecting the pattern of the electromagnetic radiation reflected by the surrounding,

wherein the detection device is staggered relative to the generation and emission device, and

an evaluation unit for evaluating of course and the arrangement of the bars of the bar pattern detected by the detection device,

wherein the evaluation unit determines, on the basis of previous examinations of the course and arrangement of bar patterns reflected by the surrounding when electromagnetic radiation, in the form of at least two bars extending at an angle to each other, has been emitted into the surrounding in different known directions, the actual orientation, corresponding to the momentarily detected bar pattern, of the chassis in the surrounding, and actuates the driving device of the chassis to attain a desired orientation.

For orientation purposes the robot system according to the invention projects a line or bar pattern into the surrounding, said line or bar pattern comprising at least two bars or lines extending relative to each other at an angle of nonzero. Such a bar pattern of electromagnetic radiation, in particular laser radiation and preferably visible light, is emitted into the surrounding by a generation device, preferably a projector. The projected pattern reflected by objects in the surrounding is detected by a detection device, in particular a camera. The detected picture of the reflected projection pattern is then evaluated in an evaluation unit. Orientation is effected, according to the invention, on the basis of the currently reflected line or bar pattern taken by the camera and on the basis of previous examinations of the course and arrangement of reflected line or bar patterns which have previously been obtained during line or bar pattern projections in different known orientations of the robot in the surrounding. According to the invention orientation is thus effected on the basis of the examination of the course (distortion) of the indivdual bars or lines of the reflected pattern.

In the robot system according to the invention orientation of the robot is not determined on the basis of a pattern recognition. Rather, the course of the individual bars or lines of the reflected pattern is examined. Said examination is carried out in particular on the basis of the determination of maximum and minimum values, i.e. similar to a mathematical function course examination. In other words, the distortion, or in particular the curvature and the direction of curvature, of the individual bars or lines is examined to determine the orientation of the robot in the surrounding on the basis of the shape of the objects in the surrounding, which need also to be known.

The projection pattern is preferably a cross comprising two lines orthogonally intersecting each other in their centers.

If the autonomously navigating robot system according to the invention is e.g. employed in a pipework made up of pipes with generally round cross-section, in particular circular pipes, which intersect each other, branch off, are curved and/or extend from at least one inspection well extending transversely to their courses, the angle of the direction of motion relative to the longitudinal axis of the pipe section in which the robot is currently located can be detected on the basis of the curvature of the bar or line patterns projected to the inner wall of the pipes and reflected by said pipes. The system according to the invention thus allows the robot to always pass through the pipe system along the longitudinal axes of the pipe sections.

The advantage offered by the robot system according to the invention is that the orientation technique according to the invention does not require any distance measurements, camera calibration or calibration of the detection device detecting the reflected pattern. The orientation technique according to the invention is based on pure determination of the current direction of motion of the robot system in the surrounding. Thus this orientation technique can be efficiently and reliably employed in regularly structured surroundings.

### BRIEF DESCRIPTION OF THE DRAWINGS

Hereunder the invention is explained in detail with reference to the drawings in which:

FIG. 1 shows a schematic representation and a side view of an embodiment of an autonomously navigating chassis of a robot system configured for inspections in sewer systems,

FIG. 2 a front view of the chassis a side view of which is shown in FIG. 1, and

FIGS. 3 to 6 examples of possible orientations of the chassis and the resultant line pattern projected to the pipe inner wall and reflected from said pipe inner wall.

### DESCRIPTION OF THE PREFERRED EMBODIMENT

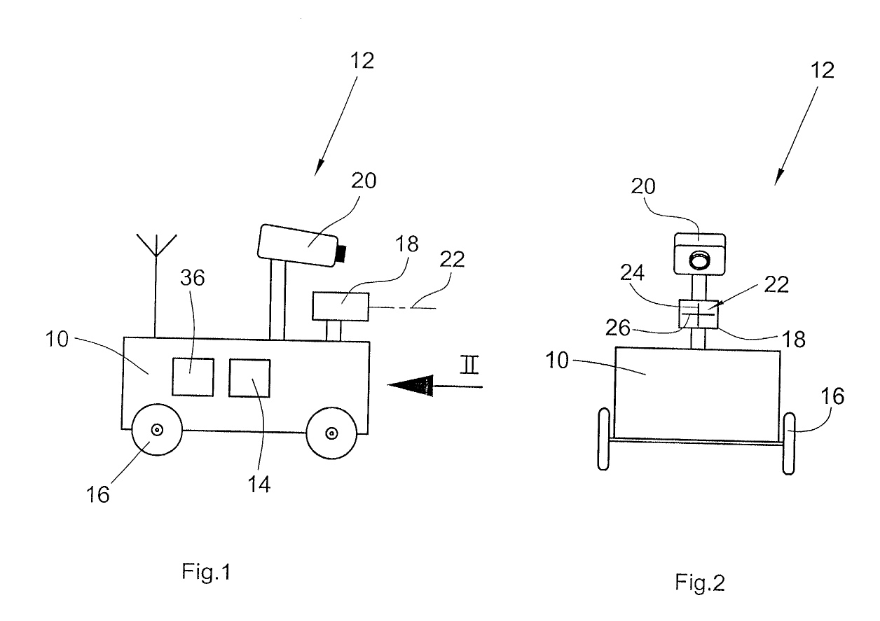

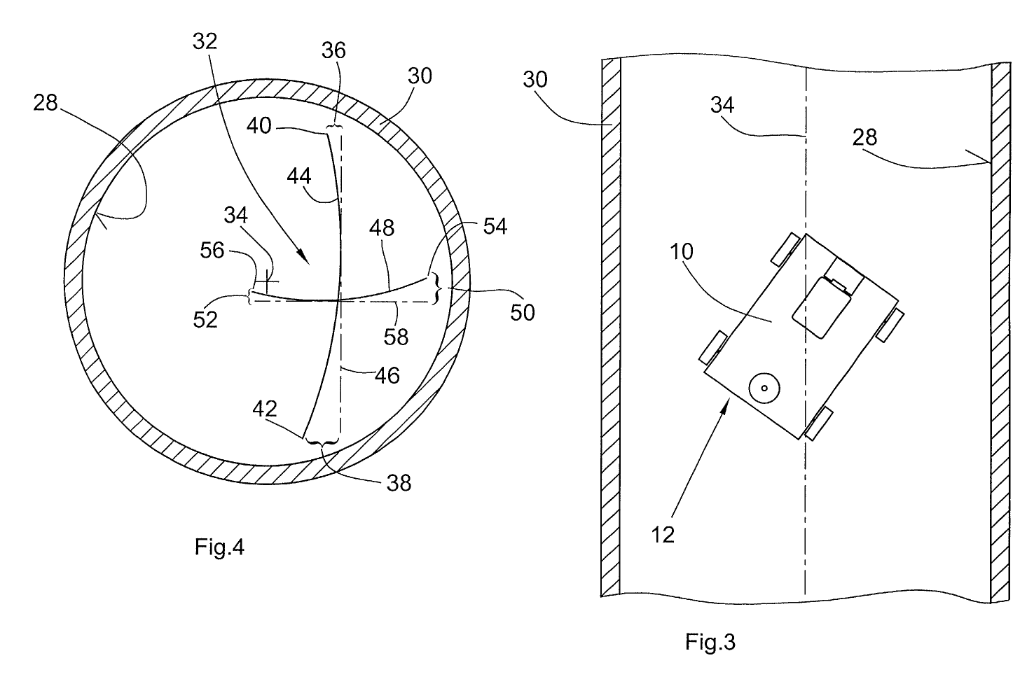

FIG. 1 shows a general view of a chassis 10 of a robot 12. Said chassis 10 is provided with a driving device, shown under 14, by means of which e.g. the wheels 16 of the chassis 10 are driven. On the chassis 10 a device, e.g. a laser projector 18, for generating electromagnetic radiation and a device, e.g. a camera 20, for detecting a pattern of electromagnetic radiation reflected by the surrounding are installed. Said camera 20 is directed to the surrounding at an angle differing from that of said laser projector 18 and receives the light pattern projected by said laser projector 18 into the surrounding and reflected by objects in the surrounding. As can be seen from the front view of the robot 12 shown in FIG. 2, said laser projector 18 projects a line pattern 22 comprising two lines 24,26 orthogonally intersecting each other. Line 24 extends, relative to the chassis 10, orthogonally to the axes of the wheels 16 while line 26 extends parallel to said axes.

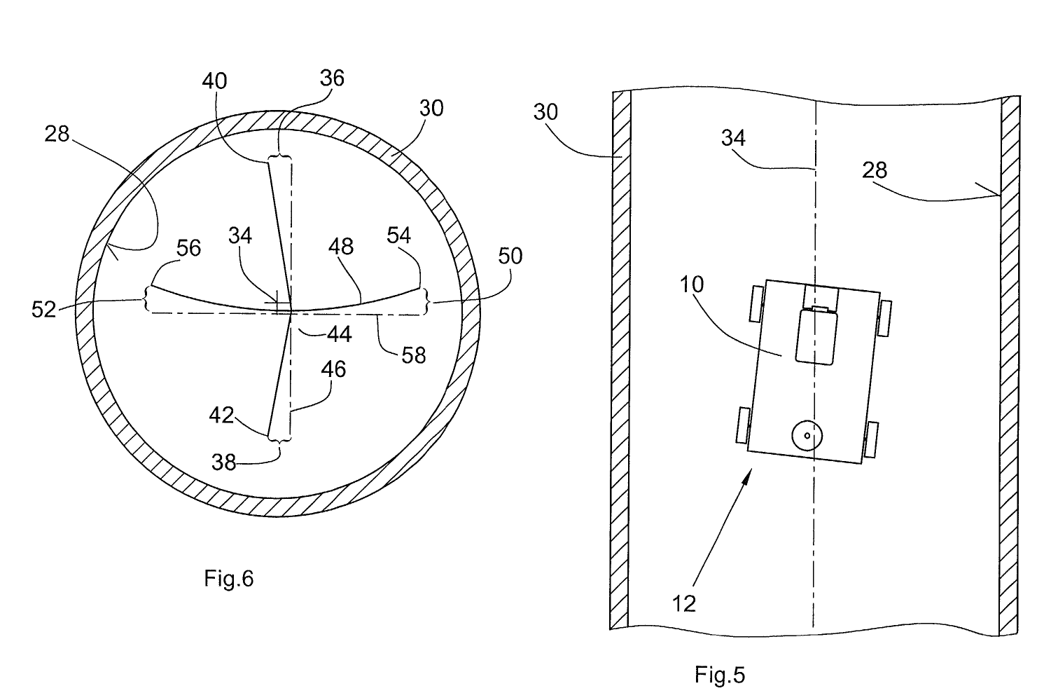

Examples of the line patterns 32 reflected by the inner wall 28 of a pipe 30 with generally round cross-section are shown in FIGS. 4 and 6. The corresponding orientation of the robot 12 relative to the longitudinal axis 34 is shown in FIGS. 3 and 5.

FIG. 4 shows e.g. how to determine the present orientation of the robot 12 by examining and analyzing the reflected light pattern 32 in an evalution unit 36 of the robot 12. For this purpose the deviations 36 and 38 of the ends 40 and 42 of the reflected line 44 of the line pattern 32 from a vertical plane 46 extending parallel to the longitudinal axis 34 of the pipe are determined. The same procedure is applied to the reflected line 48 of the line pattern 32, i.e. the deviations 50,52 of the ends 54,56 of said reflected line 48 from a horizontal plane 58 are determined. On the basis of these deviations the curvature, and in particular the course of the curvature of the reflected lines 44 and 48, can be determined. This, in turn, supplies information on the present orientation of the robot 12. Generally the following can be said: the larger the angle of the momentary direction of motion of the robot 12 relative to the longitudinal axis 34 of the pipe, the stronger the curvature of the reflected line 44. This can also be seen from the comparison of FIGS. 4 and 6. In the example shown in FIG. 5 the robot 12 merely moves at a rather small angle relative to the longitudinal axis 34 of the pipe (see comparison of FIGS. 3 and 5).

Although a preferred embodiment of the invention has been specifically illustrated and described herein, it is to be understood that minor variations may be made in the system without departing from the spirit and scope of the invention, as defined in the appended claims.

What is claimed is:

1. Autonomously navigating robot system comprising:
a chassis having a driving device for maneuvring said chassis in a surrounding,
a device arranged on said chassis for generating electromagnetic radiation and directed emission of said radiation into the surrounding,
wherein the electromagnetic radiation is emitted in the form of at least two bars extending relative to each other at an angle of non-zero,
a device arranged on the chassis for detecting a pattern of the electromagnetic radiation reflected by the surrounding,
wherein said detection device is staggered relative to the generation and emission device, and
an evaluation unit for evaluation the course and the arrangement of the bars of the bar pattern detected by the detection device,
wherein the evaluation unit determines, on the basis of previous examinations of the course and arrangement of bar patterns reflected by the surrounding when electromagnetic radiation, in the form of at least two bars extending at an angle to each other has been emitted into the surrounding in different known directions, the actual orientation, corresponding to the momentarily detected bar pattern, of the chassis in the surrounding, and actuates the driving device of the chassis to attain a desired orientation.

2. Autonomously navigating robot system according to claim 1, wherein the evaluation unit determines the actual orientation of the chassis on the basis of the distortion of the bars of the detected bar pattern.

3. Autonomously navigating robot system according to claim 1, wherein the evaluation unit determines the actual orientation of the chassis on the basis of the curvature and/or the direction of the curvature of the bars of the detected bar pattern.

4. Autonomously navigating robot system according to claim 1, wherein the generation and emission device emits the electromagnetic radiation in the form of two lines orthogonally intersecting each other in their centers.

5. Autonomously navigating robot system according to claim 1, wherein the electromagnetic radiation is visible light.

6. Autonomously navigating robot system according to claim 1, wherein the generation and emission device comprises a laser source.

7. Autonomously navigating robot system according to claim 3, wherein the evaluation unit determines the actual orientation of the chassis on the basis of the distance between one or a plurality of ends of each bar and a predetermined plane or between one or a plurality of ends and an intermediate point of each bar, said distance being orientated transversely to the course of a bar of the detected bar pattern.

8. Autonomously navigating robot system according to claim 7, wherein the evaluation unit determines the actual orientation of the chassis on the basis of an examination of the position and/or the size of the maximums and minimums of each bar of the detected bar pattern.

9. Autonomously navigating robot system according to claim 1, wherein the surrounding is regularly structured and/or contains geometrically classified objects.

10. Autonomously navigating robot system according to claim 9, wherein the surrounding is a pipe system made up of pipes with round cross-section, in particular generally circular pipes which intersect each other, branch off, are curved and/or extend from at least one inspection well extending transversely to their courses.

11. Autonomously navigating robot system according to claim 10, wherein the chassis, in its desired orientation, is directed into the longitudinal direction of a pipe.
